(19) United States
(12) Patent Application Publication
(10) Pub. No.: US 2016/0162269 A1
(43) Pub. Date: Jun. 9, 2016

(54) SECURITY EVALUATION AND USER INTERFACE FOR APPLICATION INSTALLATION

(71) Applicants: Oleg Pogorelik, Lapid (IL); Alex Nayshtut, Gan Yavne (IL); Tobias M. Kohlenberg, Portland, OR (US); James S. Baca, Corrales, NM (US)

(72) Inventors: Oleg Pogorelik, Lapid (IL); Alex Nayshtut, Gan Yavne (IL); Tobias M. Kohlenberg, Portland, OR (US); James S. Baca, Corrales, NM (US)

(21) Appl. No.: 14/558,976

(22) Filed: Dec. 3, 2014

(51) Int. Cl. G06F 9/445; G06F 21/64

(52) U.S. Cl. CPC G06F 8/61; G06F 21/64

(57) ABSTRACT

Generally, this disclosure provides systems, devices, methods and computer readable media for application installation security and privacy evaluation and indication. The system may include an application installation module configured to receive an application package for installation on a device, wherein the package comprises a list of device resources to be accessed by the application. The system may also include memory configured to store an impact score table comprising one or more security impact scores, each security impact score associated with access to one of the device resources. The system may further include a security/privacy evaluation module configured to calculate a security impact indicator (SII) based on a sum of the security impact scores selected by the accessed device resources listed in the package.

### FIELD

The present disclosure relates to application installation on a device, and more particularly, to application installation with improved security/privacy evaluation and associated visual indication.

### BACKGROUND

User devices, like smartphones and other modern computing and communication platforms, generally have the capability to add new functionality by downloading applications (or “apps”) from a provider such as an “app store” or other vendor. Applications are available for almost any purpose and, depending on the category, users may be able to choose an application from among a relatively large selection of offerings. Typically, users differentiate between available applications for download or purchase based on criteria limited to feature set, price, usability and perhaps published ratings or reviews.

During installation of the application, a user may be prompted with a list of technical details about the various possible device resources and operational systems that may be accessed by the application. Experienced and security-aware users can decide if they want to continue with the installation based on this information. The more typical user, however, may be unable to adequately evaluate how an application impacts the security and privacy protections of their device. As a result, the user might choose to install an application that requires excessive permissions and jeopardizes the security of the system, or alternatively, the user may be discouraged from installing an application that might actually be relatively safe.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a system diagram of an example embodiment consistent with the present disclosure;

FIG. 2 illustrates an impact scoring table consistent with one example embodiment of the present disclosure;

FIGS. 3(a) and 3(b) illustrate visual indicators consistent with another example embodiment of the present disclosure;

FIG. 4 illustrates a flowchart of operations of another example embodiment consistent with the present disclosure; and

FIG. 5 illustrates a system diagram of a platform of another example embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems, devices, methods and computer readable media for application installation with improved security/privacy evaluation and a user interface with an improved visual indicator of the evaluation. The device may be configured to receive an application installation package that includes a list or manifest to indicate which, if any, device resources may be accessed by the application. A table or database of weighted impact scores may be configured to indicate the relative impacts on security and/or privacy associated with each of one or more categories of accessed device resources. These device resources may include, for example, user accounts, passwords, network access, or location information. The device may be further configured to calculate a security/privacy impact indicator for the package based on a sum of these impact scores as selected by the package manifest. The impact indicator may be presented to the user in a visual format, for example through a graphical user interface and may allow the user to compare the impacts of multiple applications to select the least intrusive one.

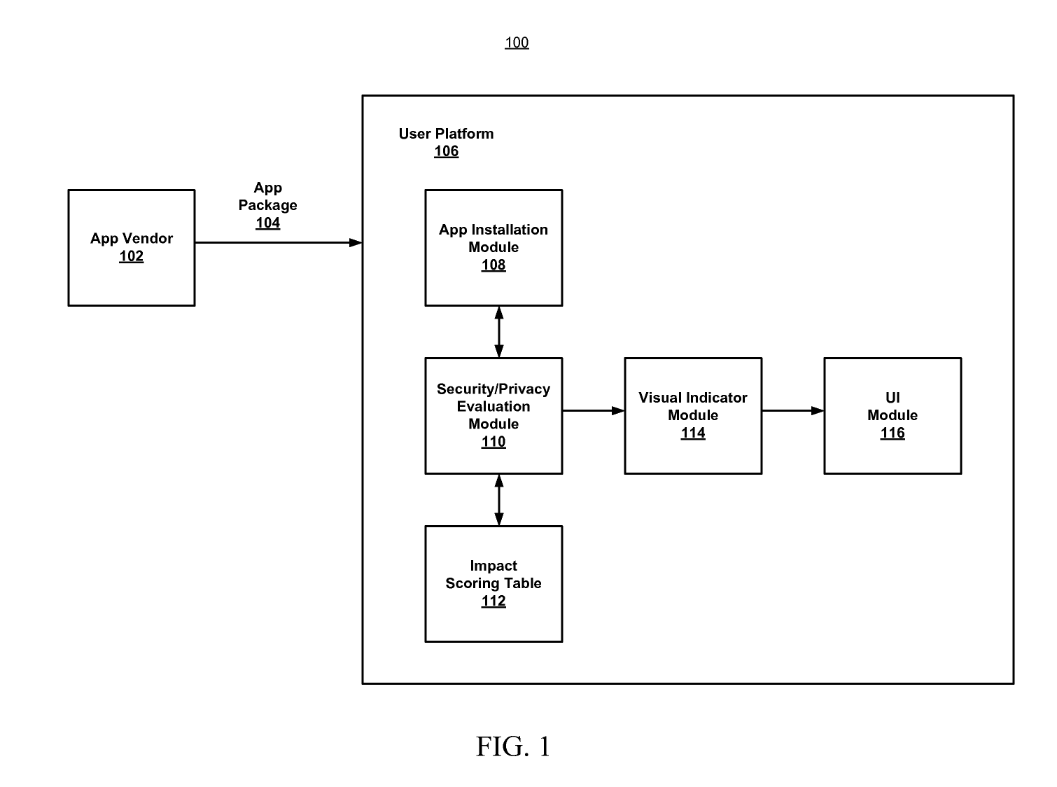

FIG. 1 illustrates a top level system diagram 100 of one example embodiment consistent with the present disclosure. A device or user platform 106 is shown, which may be configured to download application packages 104 from an application vendor 102. The application vendor 102 may be, for example, an online store or “app store” which can be accessed over the internet through a network interface. In some embodiments, the device 106 may be a smart phone, smart tablet, personal digital assistant (PDA), mobile Internet device (MID), convertible tablet, notebook, laptop computer, workstation, desktop computer, wearable device or any other device configured to download and/or install application software.

The device 106 is shown to include an application installation module 108, a security/privacy evaluation module 110, an impact scoring table (or database) 112, a visual indicator module 114 and a user interface (UI) module 116, the operations of which will be described in greater detail below.

The application installation module 108 may be configured to receive an application package for installation on the device and to perform the installation, after selection and confirmation by the user in light of the security/privacy evaluation described below. The installation package may be configured to include a list or manifest of device resources that may be accessed by the application. The list may be generated by the application developer, the vendor or a suitable third party (e.g., a certifying authority). In some embodiments, the list may be secured through techniques based on encryption, keys, digital signatures or the like to provide a suitable level of trust that the application will indeed be access restricted to the resources that are included on the list.

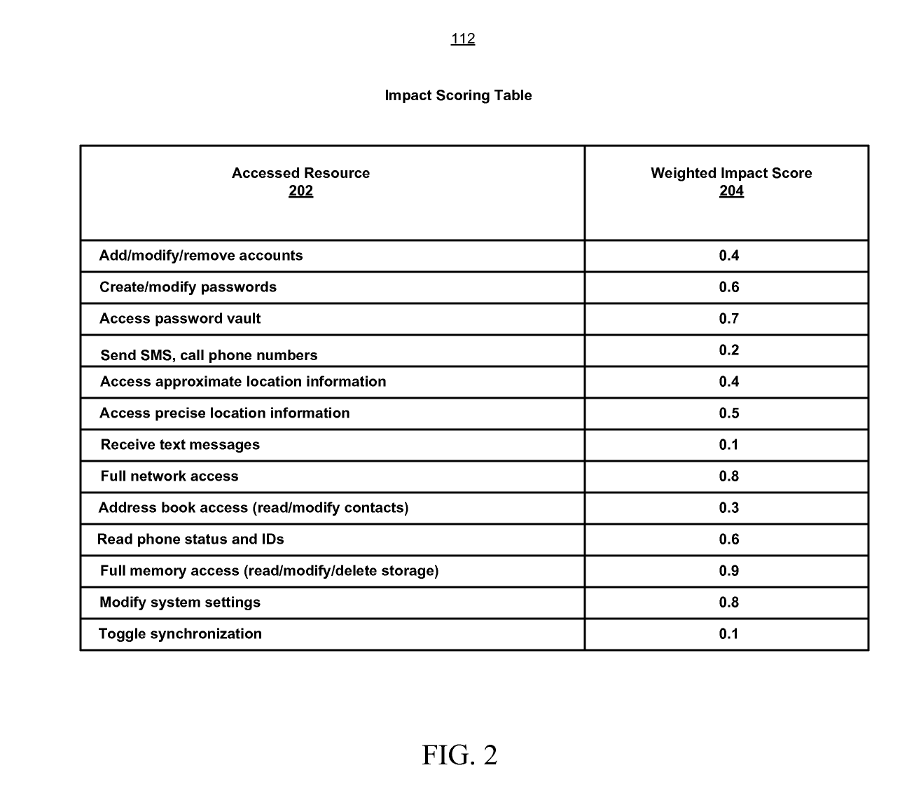

The device 106 may include memory to store an impact scoring table or database 112, configured to provide one or more security and/or privacy impact scores. Each score may be associated with access to one of the device resources, as illustrated in FIG. 2. The scores may be normalized and/or weighted to indicate an impact that is relative to each other score. For example, the scores may be normalized to a range of 0.0 to 1.0 for convenience, where the higher values indicate greater impact. Thus an accessed resource with an impact score of 0.7 will have a relatively greater impact than another accessed resource with an impact score of 0.3. In some embodiments, the impact scoring table 112 may also be secured through techniques based on encryption, keys, digital signatures or the like to prevent malicious software from tampering with the impact scores (e.g., overwriting an entry with a low impact score such as zero). In some embodiments, the table 112 may be initialized with commonly applicable default scores that may be later overwritten by an authorized entity such as, for example, an IT manager, Administrator or remote service provider.

The security/privacy evaluation module 110 may be configured to calculate a security/privacy impact indicator (SPII) based on the package manifest and the impact scoring table 112. For example, in some embodiments, the SPII may be calculated as a sum according to the following formula:

$$SPII = MaxSPII * {\sum }_{i = 0}^{N} ImpactScore ( i ) / N$$

where ImpactScore(i) represents each impact score from the scoring table 112, for which the manifest indicates that a corresponding device resource will be accessed. The sum is further normalized by dividing by N, which may be the number of non-entries in the scoring table 112, and multiplying by a scale factor MaxSPII chosen to generate values of MaxSPII in a convenient or standardized range (e.g., 10).

As an illustrative example, an installation package manifest might specify that the application can access the following device resources: full network access, precise location information and address book. In this case, using the impact scoring table from FIG. 2, which has 13 non-zero entries, the SPII would be calculated as:

SPII=10*(0.8+0.5+0.3)/13=1.23

In some embodiments, there may be separate tables for security impact scores and privacy impact scores. Thus, independent calculations may be performed to generate a separate security impact indicator (SII) and/or privacy impact indicator (PII) which may each be presented to the user individually or in combination. This may be particularly useful in situations where a user is more concerned with one aspect over the other (i.e., security versus privacy).

In some embodiments, the security/privacy evaluation module 110 may be configured to detect that the application to be installed is a security application (e.g., anti-virus, anti-malware, host intrusion prevention, firewall, etc.). The application package may include a security attribute to indicate this characteristic. In this case, the security/privacy evaluation module 110 may adjust the calculated impact indicators (SPII, SII and/or PII), to a lower impact (i.e., more secure) value. For example, an impact score associated with a security feature may have a negative value so that the resulting SPII summation is reduced. In some cases the resulting SPII may be a negative value when the security benefits of the application outweigh the other impacts. In some embodiments, a negative SPII may be indicated to the user as a separate visual feature.

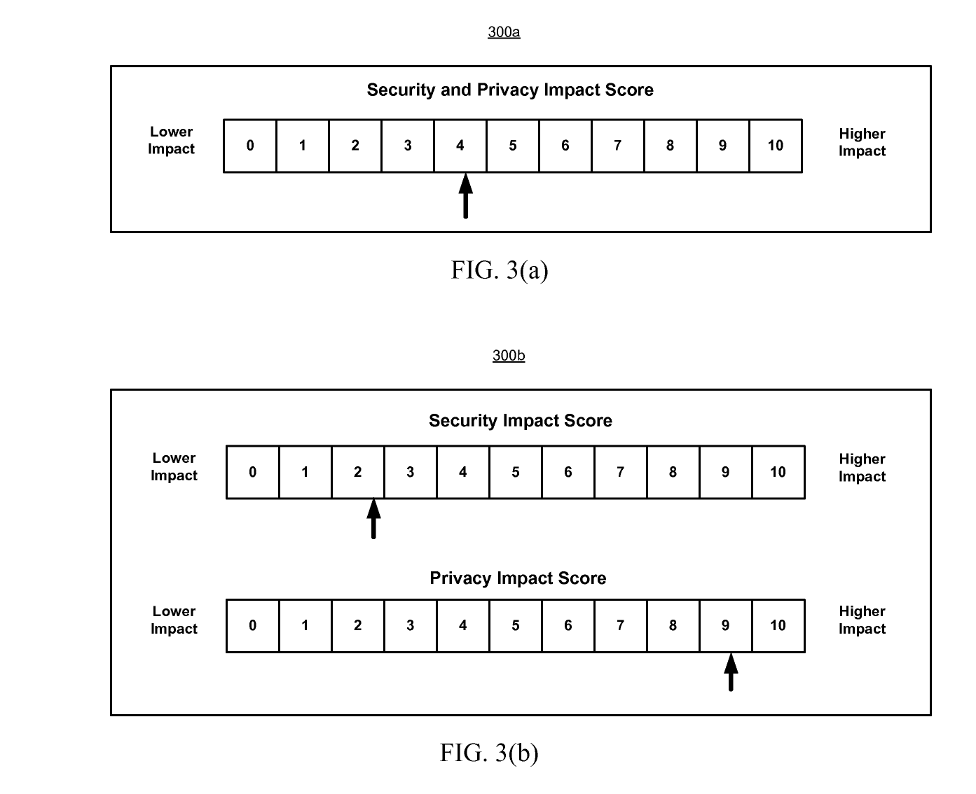

Visual indicator module 114 may be configured to generate and present a graphical visual indicator representing one or more of the calculated impact indicators (SPII, SII and/or PII), as will be explained in greater detail in connection with FIG. 3 below. A user interface (UI) module 116 may also be provided and configured to interface the visual indicator module 114 to a display element and/or input device (not shown). Thus, the user may select one or more applications for installation based on the displayed information (SPII, SII and/or PII) and indicate these choices to the application installation module 108 through the input device. Any suitable graphical visual indication may be used although it will be appreciated that a relatively easily understandable indicator can be advantageous. For example, a red color or a blinking image may enable a child to readily understand that installation of an application may be bad.

In some embodiments, one or more of modules 108, 110, 112 (or components of these modules) may be implemented by the Application vendor 102, for example on a server associated with the Application vendor.

FIG. 2 illustrates an impact scoring table 112 consistent with one example embodiment of the present disclosure. As described previously, the impact scoring table 112 may be configured to provide weighted impact scores 204 associated with an accessed resource 202 of the device. The weighted impact scores 204 may be normalized to any convenient range of values, in this example 0.0-1.0. The weighted values may be chosen to indicate relative impact of one accessed resource to another. The device resources listed in this figure, and the associated impact scores, are examples presented for illustrative purposes and are not meant to imply actual score values or be limiting in any way. In some embodiments, the resources and associated scores may be set by the device manufacturer or provider, an IT administrator, the user or any other suitable entity. In some embodiments, the scores may be updated dynamically, for example based on a history of current or previously installed applications, to provide an aggregate assessment of security/privacy based on multiple applications. The scores may also be set or updated based on a user's preference or tolerance for risk and/or the environment in which the device will be used (e.g., personal, business, mission critical, etc.).

FIGS. 3(a) and 3(b) illustrate visual indicators 300 consistent with another example embodiment of the present disclosure. In FIG. 3(a), an example visual indicator 300a is shown as a dial ranging from lower impact scores on the left to higher impact scores on the right with an arrow pointing to the calculated SPII for the application currently under consideration. In some embodiments, the dial may be configured to vary in color shading, for example from green tones on the left to red tones on the right to provide the user with a relatively simple and fast visual cue. In some embodiments, the leftmost value (e.g., zero) may be reserved to indicate that the application to be installed is a security application.

In FIG. 3(b), another example visual indicator 300b is shown in which the security impact indicator (SII) and privacy impact indicator (PII) are displayed as separate dials so the user may readily distinguish between security and privacy impacts. In some embodiments, alternative applications may be presented to the user for installation consideration, in which case multiple dial indicators may be displayed, one for each application.

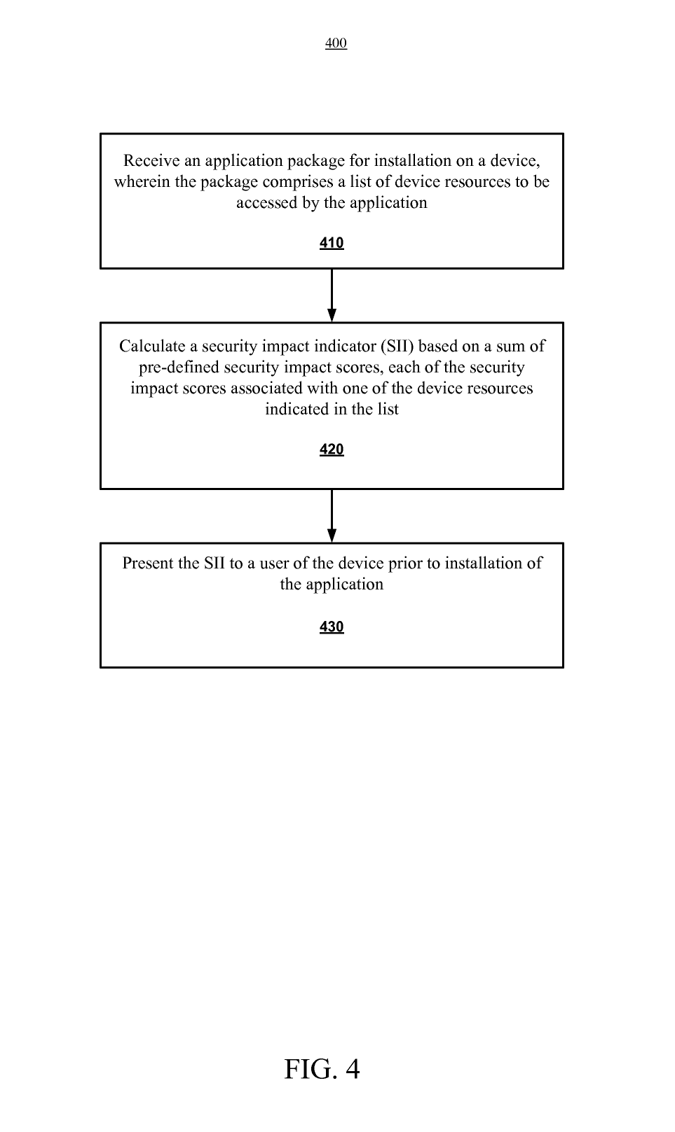

FIG. 4 illustrates a flowchart of operations 400 of another example embodiment consistent with the present disclosure. The operations provide a method for application installation with improved security and/or privacy evaluation. At operation 410, an application package is received for installation on a device. The package includes a list of device resources to be accessed by the application. At operation 420, a security impact indicator (SII) is calculated based on a sum of pre-defined security impact scores. Each of the security impact scores is associated with one of the device resources indicated in the list. At operation 430, the SII is presented to a user of the device prior to installation of the application so that the user can choose whether or not to proceed with the installation.

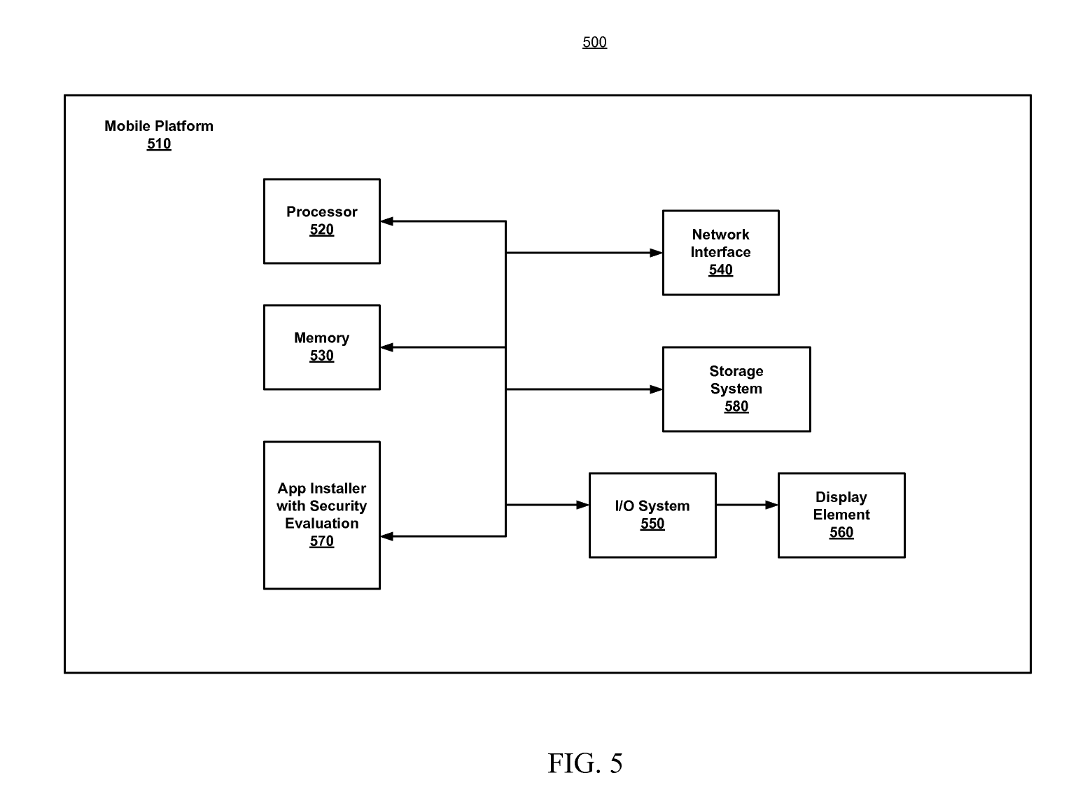

FIG. 5 illustrates a system diagram 500 of one example embodiment consistent with the present disclosure. The system 500 may be a mobile platform 510 or computing device such as, for example, a smart phone, smart tablet, personal digital assistant (PDA), mobile Internet device (MID), convertible tablet, notebook or laptop computer, or any other suitable device. It will be appreciated, however, that embodiments of the system described herein are not limited to mobile platforms, and in some embodiments, the system 500 may be a workstation or desktop computer. The device may generally present various interfaces to a user via a display element 560 such as, for example, a touch screen, liquid crystal display (LCD) or any other suitable display type.

The system 500 is shown to include a processor 520 and memory 530. In some embodiments, the processor 520 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. The memory 530 may be coupled to the processors. The memory 530 may be any of a wide variety of memories (including various layers of memory hierarchy and/or memory caches) as are known or otherwise available to those of skill in the art. It will be appreciated that the processors and memory may be configured to store, host and/or execute one or more user applications or other software modules. These applications may include, but not be limited to, for example, any type of computation, communication, data management, data storage and/or user interface task. In some embodiments, these applications may employ or interact with any other components of the mobile platform 510.

System 500 is also shown to include network interface module 540 which may include wired or wireless communication capabilities, such as, for example, Ethernet, cellular communications, Wireless Fidelity (WiFi), Bluetooth®, and/or Near Field Communication (NFC). The communications may conform to or otherwise be compatible with any existing or yet to be developed communication standards including past, current and future version of Bluetooth®, Wi-Fi and mobile phone communication standards.

System 500 is also shown to include an input/output (IO) system or controller 550 which may be configured to enable or manage data communication between processor 520 and other elements of system 500 or other elements (not shown) external to system 500.

System 500 is also shown to include a storage system 580, such as, for example, a hard disk drive (HDD) or solid state drive (SSD), coupled to processor 520 and configured to store programs, application and/or data.

System 500 is also shown to include an application installer with security evaluation 570, as described previously.

It will be appreciated that in some embodiments, the various components of the system 500 may be combined in a system-on-a-chip (SoC) architecture. In some embodiments, the components may be hardware components, firmware components, software components or any suitable combination of hardware, firmware or software.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as, for example, processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may include, for example, singly or in any combination, hardwired circuitry, programmable circuitry, state machine circuitry, and/or firmware that stores instructions executed by programmable circuitry. An application (or “app”) may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip. In some embodiments, a module may thus be implemented in software and/or firmware and may comprise one or more processes, threads or subroutines of a single process. Additionally, in some embodiments, a module may be distributed and executed on separate devices.

Thus, the present disclosure provides systems, devices, methods and computer readable media for application installation with improved security and/or privacy evaluation and indication. The following examples pertain to further embodiments.

According to Example 1 there is provided a system for application installation security evaluation. The system may include an application installation module to receive an application package for installation on a device, and the package includes a list of device resources to be accessed by the application; memory to store an impact score table including one or more security impact scores, each security impact score associated with access to one of the device resources; and a security/privacy evaluation module to calculate a security impact indicator (SII) based on a sum of the security impact scores selected by the accessed device resources listed in the package.

Example 2 may include the subject matter of Example 1, and further including a visual indicator module to present the SII to a user of the device prior to installation of the application.

Example 3 may include the subject matter of Examples 1 and 2, and the impact score table further includes one or more privacy impact scores, each privacy impact score associated with access to one of the device resources; and the security/privacy evaluation module is further to calculate the SII based on a sum of the privacy impact scores selected by the accessed device resources listed in the package.

Example 4 may include the subject matter of Examples 1-3, and the security/privacy evaluation module is further to normalize the SII to a scaled value ranging from a pre-defined lowest impact value to a pre-defined highest impact value.

Example 5 may include the subject matter of Examples 1-4, and the visual indicator module is further to generate a graphic to indicate the relative position of the SII on a visual scale ranging from the pre-defined lowest impact value to the pre-defined highest impact value.

Example 6 may include the subject matter of Examples 1-5, and the security impact scores and the privacy impact scores are normalized and weighted to indicate an impact relative to each another.

Example 7 may include the subject matter of Examples 1-6, and the device resources include one or more of account modification capability, password access, location information access, network access, memory access and contact information access.

Example 8 may include the subject matter of Examples 1-7, and the application installation module is further to identify alternative applications; the security/privacy evaluation module is further to calculate an SII for the alternative applications; and the visual indicator module is further to present the alternative application SII to the user for comparison.

Example 9 may include the subject matter of Examples 1-8, and the security/privacy evaluation module is further to detect a security attribute associated with the application package and adjust the SII to a lower impact value based on the detection.

Example 10 may include the subject matter of Examples 1-9, and the security attribute is to indicate that the application is one of an anti-virus application, an anti-malware application, a host intrusion prevention application or a firewall application.

Example 11 may include the subject matter of Examples 1-10, and the application installation module is further to receive the application package from an application vendor through a network interface.

Example 12 may include the subject matter of Examples 1-11, and the device is a smart phone, smart tablet, notebook or laptop computer.

According to Example 13 there is provided at least one computer-readable storage medium having instructions stored thereon which when executed by a processor result in the following operations for application installation security evaluation. The operations may include receiving an application package for installation on a device, and the package includes a list of device resources to be accessed by the application; calculating a security impact indicator (SII) based on a sum of pre-defined security impact scores, each of the security impact scores associated with one of the device resources indicated in the list; and presenting the SII to a user of the device prior to installation of the application.

Example 14 may include the subject matter of Example 13, and the SII is further based on a sum of pre-defined privacy impact scores, each of the privacy impact scores associated with one of the device resources indicated in the list.

Example 15 may include the subject matter of Examples 13 and 14, further including the operation of normalizing the SII to a scaled value ranging from a pre-defined lowest impact value to a pre-defined highest impact value.

Example 16 may include the subject matter of Examples 13-15, and the presenting of the SII further includes the operation of generating a graphic to indicate the relative position of the SII on a visual scale ranging from the pre-defined lowest impact value to the pre-defined highest impact value.

Example 17 may include the subject matter of Examples 13-16, and the pre-defined security impact scores and the pre-defined privacy impact scores are normalized and weighted to indicate an impact relative to each another.

Example 18 may include the subject matter of Examples 13-17, and the device resources include one or more of account modification capability, password access, location information access, network access, memory access and contact information access.

Example 19 may include the subject matter of Examples 13-18, further including the operations of: identifying alternative applications; calculating an SII for the alternative applications; and presenting the alternative application SII to the user for comparison.

Example 20 may include the subject matter of Examples 13-19, further including the operations of detecting a security attribute associated with the application package and adjusting the SII to a lower impact value based on the detection.

Example 21 may include the subject matter of Examples 13-20, and the security attribute is to indicate that the application is one of an anti-virus application, an anti-malware application, a host intrusion prevention application or a firewall application.

Example 22 may include the subject matter of Examples 13-21, and the application package is received from an application vendor through a network interface.

According to Example 23 there is provided a method for application installation security evaluation. The method may include receiving an application package for installation on a device, and the package includes a list of device resources to be accessed by the application; calculating a security impact indicator (SII) based on a sum of pre-defined security impact scores, each of the security impact scores associated with one of the device resources indicated in the list; and presenting the SII to a user of the device prior to installation of the application.

Example 24 may include the subject matter of Example 23, and the SII is further based on a sum of pre-defined privacy impact scores, each of the privacy impact scores associated with one of the device resources indicated in the list.

Example 25 may include the subject matter of Example 23 and 24, further including normalizing the SII to a scaled value ranging from a pre-defined lowest impact value to a pre-defined highest impact value.

Example 26 may include the subject matter of Examples 23-25, and the presenting of the SII further includes generating a graphic to indicate the relative position of the SII on a visual scale ranging from the pre-defined lowest impact value to the pre-defined highest impact value.

Example 27 may include the subject matter of Examples 23-26, and the pre-defined security impact scores and the pre-defined privacy impact scores are normalized and weighted to indicate an impact relative to each another.

Example 28 may include the subject matter of Examples 23-27, and the device resources include one or more of account modification capability, password access, location information access, network access, memory access and contact information access.

Example 29 may include the subject matter of Examples 23-28, further including: identifying alternative applications; calculating an SII for the alternative applications; and presenting the alternative application SII to the user for comparison.

Example 30 may include the subject matter of Examples 23-29, further including detecting a security attribute associated with the application package and adjusting the SII to a lower impact value based on the detection.

Example 31 may include the subject matter of Examples 23-30, and the security attribute is to indicate that the application is one of an anti-virus application, an anti-malware application, a host intrusion prevention application or a firewall application.

Example 32 may include the subject matter of Examples 23-31, and the application package is received from an application vendor through a network interface.

According to Example 33 there is provided a system for application installation security evaluation. The system may including means for receiving an application package for installation on a device, and the package includes a list of device resources to be accessed by the application; means for calculating a security impact indicator (SII) based on a sum of pre-defined security impact scores, each of the security impact scores associated with one of the device resources indicated in the list; and means for presenting the SII to a user of the device prior to installation of the application.

Example 34 may include the subject matter of Example 33, and the SII is further based on a sum of pre-defined privacy impact scores, each of the privacy impact scores associated with one of the device resources indicated in the list.

Example 35 may include the subject matter of Examples 33 and 34, further including means for normalizing the SII to a scaled value ranging from a pre-defined lowest impact value to a pre-defined highest impact value.

Example 36 may include the subject matter of Examples 33-35, and the means for presenting of the SII further includes means for generating a graphic to indicate the relative position of the SII on a visual scale ranging from the pre-defined lowest impact value to the pre-defined highest impact value.

Example 37 may include the subject matter of Examples 33-36, and the pre-defined security impact scores and the pre-defined privacy impact scores are normalized and weighted to indicate an impact relative to each another.

Example 38 may include the subject matter of Examples 33-37, and the device resources include one or more of account modification capability, password access, location information access, network access, memory access and contact information access.

Example 39 may include the subject matter of Examples 33-38, further including means for identifying alternative applications; means for calculating an SII for the alternative applications; and means for presenting the alternative application SII to the user for comparison.

Example 40 may include the subject matter of Examples 33-39, further including means for detecting a security attribute associated with the application package and means for adjusting the SII to a lower impact value based on the detection.

Example 41 may include the subject matter of Examples 33-40, and the security attribute is to indicate that the application is one of an anti-virus application, an anti-malware application, a host intrusion prevention application or a firewall application.

Example 42 may include the subject matter of Examples 33-41, and the application package is received from an application vendor through a network interface.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A system for application installation security evaluation, said system comprising:
an application installation module to receive an application package for installation on a device, wherein said package comprises a list of device resources to be accessed by said application;
memory to store an impact score table comprising one or more security impact scores, each security impact score associated with access to one of said device resources; and
a security/privacy evaluation module to calculate a security impact indicator (SII) based on a sum of said security impact scores selected by said accessed device resources listed in said package.

2. The system of claim 1, further comprising a visual indicator module to present said SII to a user of said device prior to installation of said application.

3. The system of claim 1, wherein said impact score table further comprises one or more privacy impact scores, each privacy impact score associated with access to one of said device resources; and wherein said security/privacy evaluation module is further to calculate said SII based on a sum of said privacy impact scores selected by said accessed device resources listed in said package.

4. The system of claim 1, wherein said security/privacy evaluation module is further to normalize said SII to a scaled value ranging from a pre-defined lowest impact value to a pre-defined highest impact value.

5. The system of claim 4, wherein said visual indicator module is further to generate a graphic to indicate the relative position of said SII on a visual scale ranging from said pre-defined lowest impact value to said pre-defined highest impact value.

6. The system of claim 1, wherein said security impact scores and said privacy impact scores are normalized and weighted to indicate an impact relative to each another.

7. The system of claim 1, wherein said device resources comprise one or more of account modification capability, password access, location information access, network access, memory access and contact information access.

8. The system of claim 2, wherein said application installation module is further to identify alternative applications; said security/privacy evaluation module is further to calculate an SII for said alternative applications; and said visual indicator module is further to present said alternative application SII to said user for comparison.

9. The system of claim 1, wherein said security/privacy evaluation module is further to detect a security attribute associated with said application package and adjust said SII to a lower impact value based on said detection.

10. The system of claim 9, wherein said security attribute is to indicate that said application is one of an anti-virus application, an anti-malware application, a host intrusion prevention application or a firewall application.

11. The system of claim 1, wherein said application installation module is further to receive said application package from an application vendor through a network interface.

12. At least one computer-readable storage medium having instructions stored thereon which when executed by a processor result in the following operations for application installation security evaluation, said operations comprising:
receiving an application package for installation on a device, wherein said package comprises a list of device resources to be accessed by said application;
calculating a security impact indicator (SII) based on a sum of pre-defined security impact scores, each of said security impact scores associated with one of said device resources indicated in said list; and
presenting said SII to a user of said device prior to installation of said application.

13. The computer-readable storage medium of claim 12, wherein said SII is further based on a sum of pre-defined privacy impact scores, each of said privacy impact scores associated with one of said device resources indicated in said list.

14. The computer-readable storage medium of claim 12, further comprising the operation of normalizing said SII to a scaled value ranging from a pre-defined lowest impact value to a pre-defined highest impact value.

15. The computer-readable storage medium of claim 14, wherein said presenting of said SII further comprises the operation of generating a graphic to indicate the relative position of said SII on a visual scale ranging from said pre-defined lowest impact value to said pre-defined highest impact value.

16. The computer-readable storage medium of claim 13, wherein said pre-defined security impact scores and said pre-defined privacy impact scores are normalized and weighted to indicate an impact relative to each another.

17. The computer-readable storage medium of claim 12, wherein said device resources comprise one or more of account modification capability, password access, location information access, network access, memory access and contact information access.

18. The computer-readable storage medium of claim 12, further comprising the operations of:
identifying alternative applications;
calculating an SII for said alternative applications; and
presenting said alternative application SII to said user for comparison.

19. The computer-readable storage medium of claim 12, further comprising the operations of detecting a security attribute associated with said application package and adjusting said SII to a lower impact value based on said detection.

20. A method for application installation security evaluation, said method comprising:
receiving an application package for installation on a device, wherein said package comprises a list of device resources to be accessed by said application;
calculating a security impact indicator (SII) based on a sum of pre-defined security impact scores, each of said security impact scores associated with one of said device resources indicated in said list; and
presenting said SII to a user of said device prior to installation of said application.

21. The method of claim 20, wherein said SII is further based on a sum of pre-defined privacy impact scores, each of said privacy impact scores associated with one of said device resources indicated in said list.

22. The method of claim 20, further comprising normalizing said SII to a scaled value ranging from a pre-defined lowest impact value to a pre-defined highest impact value.

23. The method of claim 22, wherein said presenting of said SII further comprises generating a graphic to indicate the relative position of said SII on a visual scale ranging from said pre-defined lowest impact value to said pre-defined highest impact value.

24. The method of claim 21, wherein said pre-defined security impact scores and said pre-defined privacy impact scores are normalized and weighted to indicate an impact relative to each another.

25. The method of claim 20, wherein said device resources comprise one or more of account modification capability, password access, location information access, network access, memory access and contact information access.

26. The method of claim 20, further comprising:
identifying alternative applications;
calculating an SII for said alternative applications; and
presenting said alternative application SII to said user for comparison.

27. The method of claim 20, further comprising detecting a security attribute associated with said application package and adjusting said SII to a lower impact value based on said detection.
